(19) United States
(12) Patent Application Publication
(10) Pub. No.: US 2025/0352837 A1
(43) Pub. Date: Nov. 20, 2025

(54) ACTION SPORT FALL PROTECTION SYSTEM

(71) Applicants: David Shyne, Brooklyn Park, MN (US); Mark Muller, Hopkins, MN (US)

(72) Inventors: David Shyne, Brooklyn Park, MN (US); Mark Muller, Hopkins, MN (US)

(21) Appl. No.: 19/213,828

(22) Filed: May 20, 2025

Related U.S. Application Data
(60) Provisional application No. 63/649,791, filed on May 20, 2024.

(51) Int. Cl. A62B 35/00

(52) U.S. Cl. CPC A62B 35/0056; A62B 35/0037; A62B 35/0081; A62B 35/0093

(57) ABSTRACT

A sporting venue includes a sporting course having a first topography over which an athlete traverses and a fall protection system. The fall protection system includes an overhead support structure having one or more cables or trusses extending over the sporting course and configured to support the weight of the athlete, a trolley slidably engaged with the overhead support structure and configured to travel with the athlete while traversing the sporting course, a self-retracting fall arrestor comprising a lanyard operably coupled to a braking system configured to prevent or slow a fall of the athlete, and a lanyard extending from the self-retracting fall arrestor and configured to couple to a harness of the athlete.

### CROSS-REFERENCE TO RELATED APPLICATIONS

This application claims priority to U.S. Provisional Application No. 63/649,791, titled ACTION SPORT FALL PROTECTION SYSTEM, filed May 20, 2024, which is hereby incorporated by reference in its entirety.

### TECHNICAL FIELD

The present disclosure is directed to fall protection systems for use with indoor and outdoor action sport venues.

### BACKGROUND

In the realm of action sports and extreme sports, traditional protective gear such as helmets, knee pads, and wrist guards remains essential to protect athletes from injury. Recent advances in specialized materials and ergonomic designs may improve safety and performance of traditional protective gear. In addition to personal protective equipment, advancements in safety infrastructure, including features like foam pits and impact-absorbing surfaces, contribute to a comprehensive approach to fall protection. However, fall protection system may enable athletes to more quickly and confidently develop particular skills while mitigating risk of injury.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

The present disclosure describes fall protection systems for action sports and extreme sports. The fall protection systems are configured to reduce the likelihood of an athlete impacting the sporting course, reduce the force of the athlete impacting the sporting course, or both.

The described fall arrest systems may include at least one overhead support structure, at least one trolley, at least one self-retracting fall arrestor, and a lanyard. The at least one overhead support structure may include one or more metal cables or trusses configured to support the weight of the athlete during a fall event. The overhead support structure traverses over at least a portion of the sporting course. The at least one trolley is slidably engaged with the overhead support structure and configured to travel with the athlete while traversing the sporting course. The at least one self-retracting fall arrestor is configured to prevent or slow a fall of the athlete. The self-retracting fall arrestor includes a braking system that is one of electromagnetic brake (e.g., using eddy current braking), a centripetal force brake (e.g., using friction braking), or hydraulic brake (e.g., using flow of a fluid for braking). The lanyard extends from the self-retracting fall arrestor for coupling to a harness of the athlete. In some examples, the overhead support structure may include one or more longitudinal members and a lateral member coupled to the longitudinal member in a sliding engagement (e.g., using trolleys or the like), such that the overhead support structure may traverse a two-dimensional area over the sporting course.

In some examples, the disclosure describes a sporting venue including a sporting course having a first topography over which an athlete traverses; an overhead support structure including one or more cables or trusses extending over the sporting course and configured to support the weight of the athlete; a trolley slidably engaged with the overhead support structure and configured to travel with the athlete while traversing the sporting course; a self-retracting fall arrestor including a lanyard operably coupled to a braking system configured to prevent or slow a fall of the athlete, where the braking system includes at least one of an electronic brake, an electromagnetic brake, a centripetal force brake, or a hydraulic brake; and a lanyard extending from the self-retracting fall arrestor and configured to couple to a harness of the athlete.

In some examples, the disclosure describes a method for preventing falls on sporting courses that includes providing an overhead support structure configured to traverse over at least a portion of the sporting course and support the weight of the athlete during a fall event; attaching a trolley slidably engaged with the overhead support structure to travel with the athlete while traversing the sporting course; providing a self-retracting fall arrestor including a lanyard operably coupled to a braking system, where the braking system includes at least one of an electromagnetic brake, a centripetal force brake, or a hydraulic brake configured to prevent or slow a fall of the athlete, and where the lanyard is configured to couple to a harness of the athlete; and causing, in response to a fall event, activation of the braking system to at least reduce a speed of an extension of the lanyard from the self-retracting fall arrestor.

In some examples, the disclosure describes a fall protection system for an action sports course, including an overhead support structure having one or more cables or trusses extending over the sporting course and configured to support the weight of the athlete; a trolley slidably engaged with the overhead support structure and configured to travel with the athlete while traversing the sporting course; a self-retracting fall arrestor including a braking system that is electromagnetic, centripetal force, or hydraulic, wherein the braking system is configured to prevent or slow a fall of the athlete; and a lanyard extending from the self-retracting fall arrestor for coupling to a harness of the athlete.

The foregoing general description of the illustrative embodiments and the following detailed description thereof are merely exemplary aspects of the teachings of this disclosure and are not restrictive.

### BRIEF DESCRIPTION OF FIGURES

The disclosure can be understood in consideration of the following detailed description of various embodiments in connection with the accompanying drawings.

FIG. 1 is a conceptual diagram illustrating an example sporting venue having a sporting course and a fall protection system.

FIG. 2 is a conceptual diagram illustrating an example sporting venue having a sporting course and a fall protection system.

FIG. 3 is a conceptual diagram illustrating an example sporting venue including a sporting course and a fall protection system having an overhead support structure configured to enable traversal of at least a portion of fall protection system in two-dimensions.

FIGS. 4A and 4B are conceptual cross-sectional views of an example a fall protection system trolley.

FIGS. 5A and 5B are conceptual side views of an example a fall protection system trolley.

FIG. 6 is a flow diagram illustrating an example technique 600 for using the fall protection systems and associated devices described herein.

FIGS. 7A through 7D are conceptual diagrams illustrating a C-shaped channel track system and maglev trolley assembly.

FIG. 8 is a conceptual diagram illustrating an example system diagram of a cable robot tracking system.

FIG. 9 is a conceptual diagram illustrating an example block diagram of an athlete tracking system.

FIG. 10 is a conceptual diagram illustrating a flowchart of an example method for operating a cable robot tracking system.

### DETAILED DESCRIPTION

For purposes of promoting an understanding of the principles of the disclosure, reference will now be made to the embodiments illustrated in the drawings, and specific language will be used to describe the same. It will nonetheless be understood that no limitation of the scope of the disclosure is intended by the illustration and description of certain embodiments of the disclosure. In addition, any alterations and/or modifications of the illustrated and/or described embodiment(s) are contemplated as being within the scope of the present disclosure. Further, any other applications of the principles of the disclosure, as illustrated and/or described herein, as would normally occur to one skilled in the art to which the disclosure pertains, are contemplated as being within the scope of the present disclosure.

The present disclosure describes fall protection systems for action sports and extreme sports. Action sports and extreme sports may include, but are not limited to, skateboarding, inline skating, BMX biking, downhill skiing and snowboarding, mountain biking and boarding, canyoning, bouldering, and the like. The described fall protection systems are integrated with a sporting course and configured to reduce the likelihood of an athlete impacting the sporting course, reduce the force of the athlete impacting the sporting course, control a direction of the athlete during a fall event or after impact with the sporting course, or combinations thereof. The fall protection systems may include an overhead support structure to which a trolley is moveably engaged for supporting a self-retracting fall arrestor operably coupled via a lanyard to an athlete. The fall protection systems may be used to supplement traditional protective gear to provide greater protection to the athlete and enable greater confidence in performing difficult maneuvers.

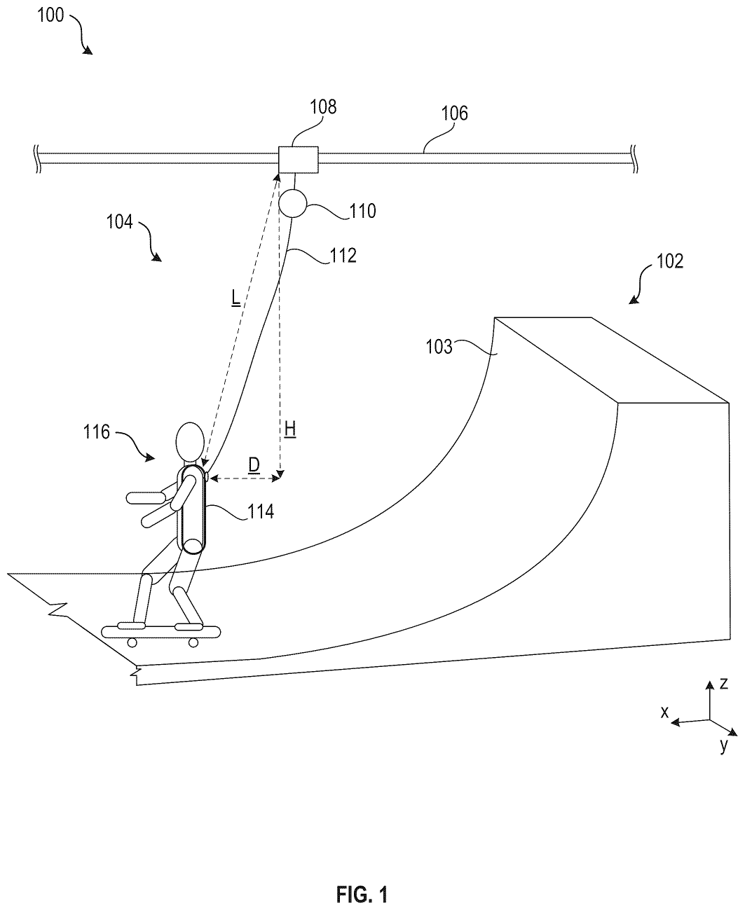

FIG. 1 is a conceptual diagram illustrating an example sporting venue 100 having a sporting course 102 and a fall protection system 104. Fall protection system 104 includes an overhead support structure 106 to which a trolley 108 is moveably engaged for supporting a self-retracting fall arrestor 110 operably coupled via a lanyard 112 to a harness 114 worn by an athlete 116. As discussed in further detail below, fall protection system 104 is configured to reduce the likelihood of athlete 116 impacting sporting course 102 in an uncontrolled manner during a fall event, reduce the force of athlete 116 impacting sporting course 102 during a fall event, control a direction of athlete 116 during a fall event or after impact with sporting course 102, or combinations thereof.

As illustrated in FIG. 1, sporting course 102 includes a quarter pipe ramp 103. Generally, sporting course 102 may include one or more surfaces configured for use in any suitable action sport or extreme sport. For example, sporting course 102 may include any surface or structure on which or through which athlete 116 is engaged in traversing. Other example sporting courses 102 may include, but are not limited to, earth surfaces, snow surfaces, concrete surfaces, rock surfaces, wooden ramps, concrete ramps, metal rails, trees, or the like. Sporting course 102 provides a unique topography as a natural terrain, man-made ramps or obstacles, or both. For example, sporting course 102 may include a vert ramp, a street course, a downhill snow halfpipe, a downhill snow jump, or other natural or manmade action sport or extreme sport courses.

Sporting course 102 may extend in a x-y plane and may include changes in the z-direction, either as an inclined/declined surfaces or elevation changes. While described relative to the Cartesian coordinate system (e.g., x-y-z axes illustrated in FIG. 1), other coordinate systems may be used to describe the topography of the sporting course. Also, the reference of the coordinate system may include an x-y plane defined generally by earth's surface or an average of the surface over which the sporting course extends. Additionally, or alternatively, the reference of the coordinate system may include a z-direction defined by the gravitational force of earth or normal to the average of the surface over which the sporting course extends.

Fall protection system 104 includes overhead support structure 106. Overhead support structure 106 is configured to support a force applied by athlete 116 to lanyard 112 during a fall event. Overhead support structure 106 may include one or more beams, cables, trusses, ropes, other suitable structures that traverse over at least a portion of sporting course 102 and provide a strong and durable support system for athlete 116 during use, or combinations thereof. The materials used for overhead support structure 106 may include, but are not limited to, one or more metals, polymers, natural or synthetic fibers, or combinations thereof. In some examples, the structure and/or materials of overhead support structure 106 may be selected based on the environment in which overhead support structure 106 is used, predicted force loading of the overhead support structure 106 during a fall event, or both. For example, overhead support structure 106 may include metal cables having a known strength and durability, metal trusses having a known flexural strength, or combinations thereof.

In some examples, overhead support structure 106 may define a topography that is correlated to the topography of sporting course 102. For example, z-direction changes in a topography of sporting course 102 may be reflected by z-direction changes in overhead support structure 106. In some examples, such z-direction changes may be directly correlated in distance or may be different, e.g., a z-direction change of 10 feet (3 meter) in sporting course 102 may be reflected in a 5 feet (1.5 meter) z-direction change in overhead support structure 106.

Moreover, z-direction changes in overhead support structure 106 may be more gradual than corresponding z-direction changes in sporting course 102. For example, sporting course 102 may include a z-direction change of 10 feet over a distance of 1 foot and a corresponding z-direction change of overhead support structure 106 may be 5 feet over a distance of 5 feet.

Generally, the correlation of z-direction changes between sporting course 102 and overhead support structure 106 may be selected to reduce material used for fabrication of overhead support structure 106, reduce or prevent backswing of athlete 116 into a portion of sporting course 102 during a fall event, facilitate travel of trolley 108 along overhead support structure 106, maintain below a selected threshold a force applied by athlete 116 to trolley 108 to enable trolley 108 to travel along overhead support structure 106, reduce or prevent freewheel travel of trolley 108 along overhead support structure 106 such as when athlete 116 changes directions, maintain a selected distance between sporting course 102 and overhead support structure 106 at select locations on sporting course 102, or the like.

In some examples, overhead support structure 106 may be configured to traverse a two-dimensional area over sporting course 102. For example, overhead support structure 106 may include one or more longitudinal members and a lateral member coupled to the longitudinal member in a sliding engagement, such that the lateral member can traverse a two-dimensional area over sporting course 102.

Trolley 108 is movably engaged with at least a portion of overhead support structure 106. For example, trolley 108 is configured to traverse the portion of overhead support structure 106 and remain within a select distance range from athlete 116. The select distance range is defined by one or more of a linear distance L, a lateral distance D extending in the x-y plane, a vertical distance H extending parallel the z-axis, or a combination thereof. In some examples, the select distance range is within a range from about 2 feet (ft) to about 20 ft, such as within a range from about 3 ft to about 15 ft.

Trolley 108 may be configured to ensure smooth travel, easy maintenance, and durability under various conditions. In some examples, trolley 108 may include a zipline trolley, an I-beam trolley, or other suitable trolley or pully. Trolley 108 may be made of materials such as metal, plastic, or composite materials and incorporates features like rounded edges, low-friction coatings, adjustable wheel sizes, and quick-release mechanisms for detachment from the overhead support structure during a fall event.

Trolley 108 may include a detachable feature, such as a side-face-plate or gate, that allows for toolless coupling or decoupling of trolley 108 to overhead support structure 106, to facilitate maintenance, or to enable replacement of components, without disrupting the use of other components of fall protection system 104. The detectable feature of trolley 108 may be particularly useful in high-intensity action sports and extreme sports, where frequent falls and wear and tear on equipment are common, compared to fall systems requiring tools or lapse of service to couple or decoupled a trolley.

Trolley 108 may include one or more wheels configured to contact and travel along a surface of overhead support structure 106. The one or more wheels may reduce friction between trolley 108 and overhead support structure 106.

In some examples, trolley 108 may include a friction device configured to, when under a select load, cause a select amount of friction to be generated between trolley 108 and overhead support structure 106. The select load may include a minimum load, such as a load indicative of an athlete experiencing an airborne event or a direction change. In this way, trolley 108 may be configured to provide a greater rate of deceleration when an athlete changes directions, thereby reducing or preventing trolley 108 from overriding or otherwise travelling too far past the athlete when the athlete 116 changes directions. Similarly, when athlete 116 is experiencing an airborne event, trolley 108 may be configured to provide a greater rate of deceleration or remain stationary. In the case of a fall event immediately following the airborne event, the trolley 108 may thereby be in a better position to support athlete 116 compared to a system in which trolley 108 continued to roll freely during the airborne event.

Additionally, or alternatively, the select load may include a maximum load, such as a load indicative of an athlete experiencing a fall event. In this way, when athlete 116 is experiencing a fall event, trolley 108 may be configured to provide a greater rate of deceleration or otherwise remain stationary. In examples in which the select load is a maximum load indicative of a fall event, the friction between trolley 108 and overhead support structure may be great enough to prevent or substantially reduce movement of trolley 108 during the fall event.

Self-retracting fall arrestor 110 is coupled to trolley 108 via a carabiner, a swivel, other quick release mechanical couplings, or combinations thereof. Self-retracting fall arrestor 110 is configured to control an acceleration associated with a fall event of athlete 116. Although describe with reference to a fall event, in other example, self-retracting fall arrestor 110 may configured to control an uncontrolled movement associate with another type of event, such as, for example, uncontrolled travel toward a boundary of sporting course 102, an obstacle of sporting course 102, or the like.

Self-retracting fall arrestor 110 may control the acceleration associated with a fall event, or uncontrolled movement associate with other events, via a braking system. The braking system is configured to prevent or slow the acceleration or descent of athlete 116, e.g., during a fall event. The braking system can be configured as electromagnetic brake (e.g., eddy current brake), a centripetal force friction brake, or a hydraulic brake. Each of these braking systems may provide advantages depending on various factors such as weather conditions, athlete weight, and the specific requirements of the fall arrest system. For example, an electromagnetic brake may be more suitable in dry conditions, while a hydraulic brake may perform better in wet or icy conditions. In some examples, self-retracting fall arrestor 100 may include an auto-belay system as described in, for example, U.S. Pat. No. 9,962,588 and U.S. patent application Ser. Nos. 16/738,723 and 17/179,258, each of which is incorporated by reference herein in its entirety.

In some examples, self-retracting fall arrestor 110 may be configured to detect, via processing circuitry and memory device operably coupled to one or more sensors, when a fall is imminent or has occurred. Example sensors may include, for example, accelerometers, gyroscopes, inertial sensors, impact detection sensor, or combinations thereof. Such sensors may transmit to the processing circuitry a signal indicative of a fall event. Upon determining that a fall event is imminent or has occurred, processing circuitry may be configured to, based on instructions retrieved from the memory device, activate a braking system of self-retracting fall arrestor 110. The processing circuitry, memory device, and sensors may be powered by a suitable power source, such as a battery housed in self-retracting fall arrestor 110, that can optionally be charged by an electromagnetic brake regeneration device of the self-retracting fall arrestor 110.

Additionally, or alternatively, the processing circuitry may be configured to, based on instructions retrieved from the memory device, generate a fall event signal indicative of the fall event and transmit the fall event signal to an alert device. The alert device may, based on the fall event signal, produce an alert understandable by a human or machine. For example, the alert may include a visual alert, an audible alert, a tactile alter, or the like. Additionally, or alternative, the fall event signal may be receivable by a remote computing device, such as a smart phone or the like, which may generate the alert. In this way, fall proception system 104 may be configured to alert operators or other persons that may assist athlete 116 after a fall event.

Lanyard 112 is operable coupled to self-retracting fall arrestor 110 and harness 114 worn by athlete 116. Lanyard 112 is configured to ensure that athlete 116 remains securely attached to overhead support structure 106 during use. Self-retracting fall arrestor 110 houses at least a portion of lanyard 112, retract lanyard 112 when a force on lanyard 112 is below a first threshold force and enable lanyard 112 to extend when the force on lanyard 112 is above a second threshold force. In some examples, the first threshold force and the second threshold force is the same or substantially similar (e.g., the first threshold force may be greater than about 90% of the second threshold force). In some examples, the first threshold force is within a range from about 5 Newton (N) to about 50 N, such as within a range from about 10 N to about 25 N. The first threshold force may be selected so as to prevent the first threshold force from impacting a balance of athlete 116. In some examples, the first threshold force is greater than a force required to cause trolley 108 to move along overhead supporting structure 106 or a force required to cause trolley 108 moving in a first direction along overhead support structure 106 to move in a second opposing direction within a time period of less than 2 second, such as less than 1 second, or less than 0.5 second.

Lanyard 112 includes one or more of a cable, a webbing, or a rope of any suitable material. Example materials of lanyard 112 include, but are not limited to, metal, steel, one or more polymers, nylon, polyester, aramid, carbon fiber, ultra-high-molecular-weight polyethylene, or the like. The design of lanyard 112 may meet or exceed industry standards for fall arrest systems, such as those set forth in ANSI Z359.1, the contents of which is incorporated by reference herein in its entirety.

The length of lanyard 112 may be calculated to ensure safe coupling with harness 114 without causing any excessive slack or tension that could compromise an effectiveness of fall protection system 104.

In some examples, lanyard 112 includes shock-absorbing components, impact-resistant materials, and reflective or luminescent elements to increase visibility during low light conditions. These features help to reduce the risk of entanglement or injury during use, making lanyard 112 a functional component of fall protection system 104.

Harness 114 is configured to be worn by athlete 116 and mechanically coupled to lanyard 112. For example, harness 114 may include a d-ring securely woven into a webbing of harness 114 to which a carabiner, a swivel, other quick release mechanical couplings, or combinations thereof may be coupled. In some examples, harness 114 is configured to accommodate a selected weight, size, and body shape of athlete 116 to provide a secure and comfortable fit while minimizing any potential for injury during use.

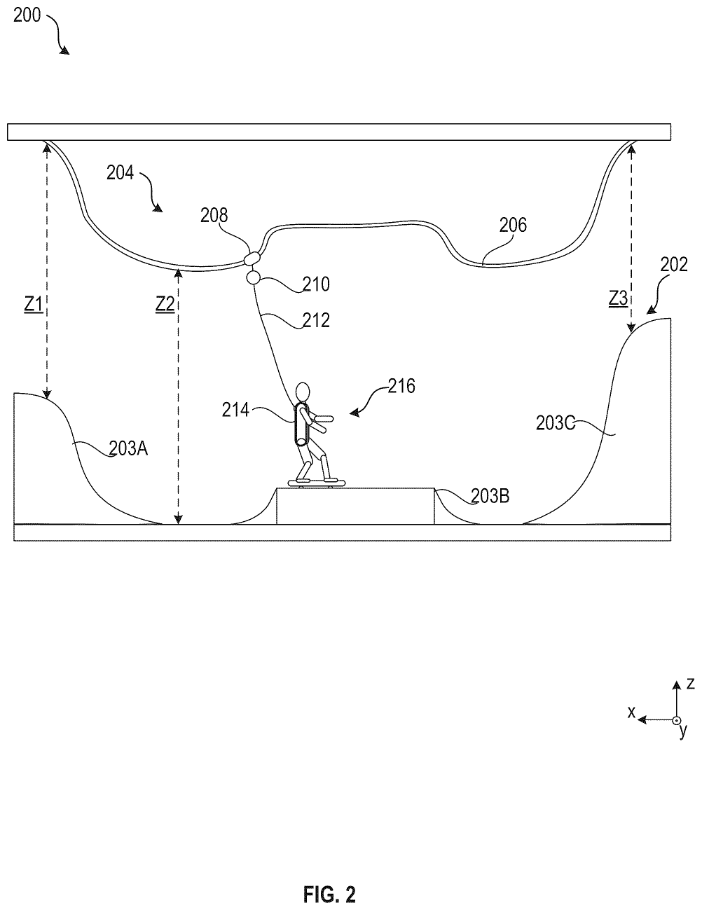

FIG. 2 is a conceptual diagram illustrating an example sporting venue 200 having a sporting course 202 and a fall protection system 204. Sporting venue 200, sporting course 202, and fall protection system 204 may be the same as or substantially similar to sporting venue 100, sporting course 102, and fall protection system 104 described above in reference to FIG. 1, except for the differences described herein. For example, similar to fall protection system 104, fall protection system 204 includes an overhead support structure 206 to which a trolley 208 is moveably engaged for supporting a self-retracting fall arrestor 210 operably coupled via a lanyard 212 to a harness 214 worn by an athlete 216.

Sporting course 202 includes a first topography defined by obstacles 203A, 203B, and 203C (collectively, obstacles 203). Obstacles 203 include quarter pipe ramps and a transition ledge. In other examples, obstacles 203 include any other suitable structure for use in action sports or extreme sports.

Overhead support structure 206 defines a second topography that is correlated to the topography of sporting course 202. For example, z-direction changes in the first topography of sporting course 202 are reflected by z-direction changes in overhead support structure 206.

For at least a portion of sporting course 202 and overhead support structure 206, the z-direction changes (i.e., the z-differential) are directly correlated in distance. For example, z-differential Z1 at a first location on sporting course 202 and overhead support structure 206 is the same as z-differential Z2 at a second, different location on sporting course 202 and overhead support structure 206.

For at least a portion of sporting course 202 and overhead support structure 206, the z-differentials are different. For example, z-differential Z3 at a third location on sporting course 202 and overhead support structure 206 is less than Z1 and Z2. Moreover, z-direction change in overhead support structure 206 at or adjacent Z3, e.g., quarter pipe 203C, is more gradual than corresponding z-direction change in sporting course 102.

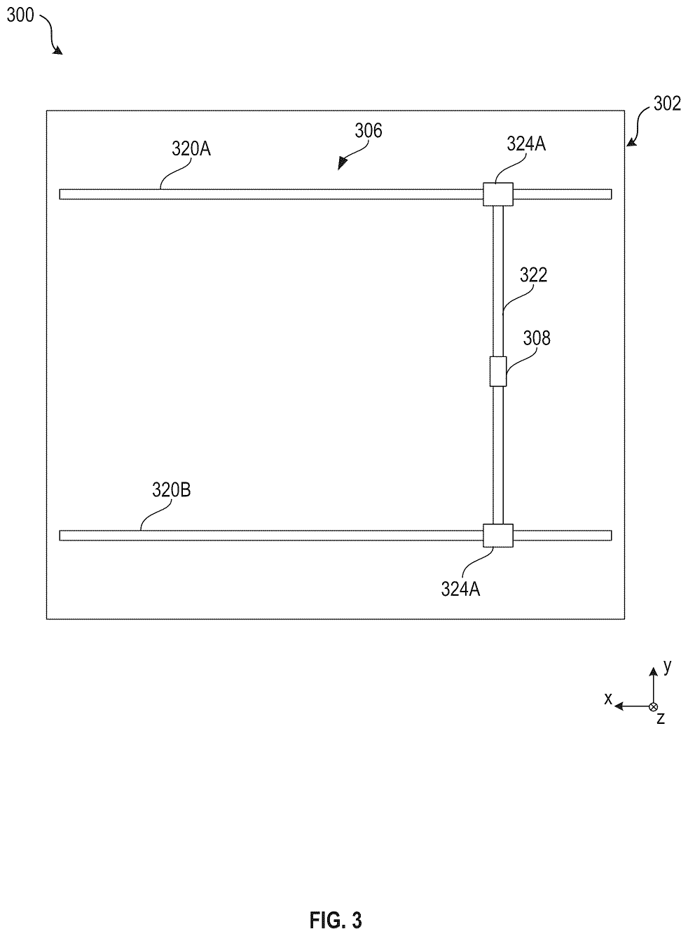

FIG. 3 is a conceptual diagram illustrating an example sporting venue 300 including a sporting course 302 and a fall protection system 304 having an overhead support structure 306 configured to enable traversal of at least a portion of fall protection system 304 in two-dimensions. Sporting venue 300, sporting course 302, and fall protection system 304 may be the same as or substantially similar to sporting venues 100 or 200, sporting course 102 or 202, and fall protection system 104 or 204, described above in reference to FIGS. 1 and 2, except for the differences described herein.

Overhead support structure 306 includes two longitudinal members 320A, 320B (collectively, longitudinal members 320) and lateral member 322. Lateral member 322 is coupled to longitudinal members 320 in sliding engagement. For example, lateral member 322 is fixedly coupled to trolleys 324A and 324B (collectively, trolleys 324) which are coupled to longitudinal members 320 in sliding engagement. This enables movement of lateral member 322 in the x-direction as illustrated in FIG. 3.

Trolley 308 is operatively coupled to lateral member 322 in the same or substantially similar manner as described above in reference to trolleys 108 and 208. Hence, trolley 308 is configured to traverse lateral member 322 in the y-direction as illustrated in FIG. 3.

By enabling movement in the x-direction via translation of lateral member 322 relative to longitudinal members 320 and the y-direction via translation of trolley 308 along lateral member 322, fall protection 304 is system configured to enable trolley 308 (as well as a self-retracting fall arrestor and lanyard extending therefor, not illustrated) to travel with an athlete (not illustrated) in two-dimensional space (i.e., the x-y plane) as the athlete traverses portions of sporting course 302. This configuration may reduce an amount of the lanyard extended from the self-retracting fall arrestor, which may reduce or prevent backswing of athlete during a fall event or reduce an amount of elastic extension or stretching of the lanyard attributed to the amount of lanyard extended from the self-retracting fall arrestor during a fall event. Therefore, fall protection system 304 provides additional benefit relative to a fall protection system including a single linear overhead support structure when sporting course 302 extends over a two-dimensional area of a select dimension (e.g., width, length, or both) relative to a height of overhead support structure 306 relative to at least a portion of sporting course 302.

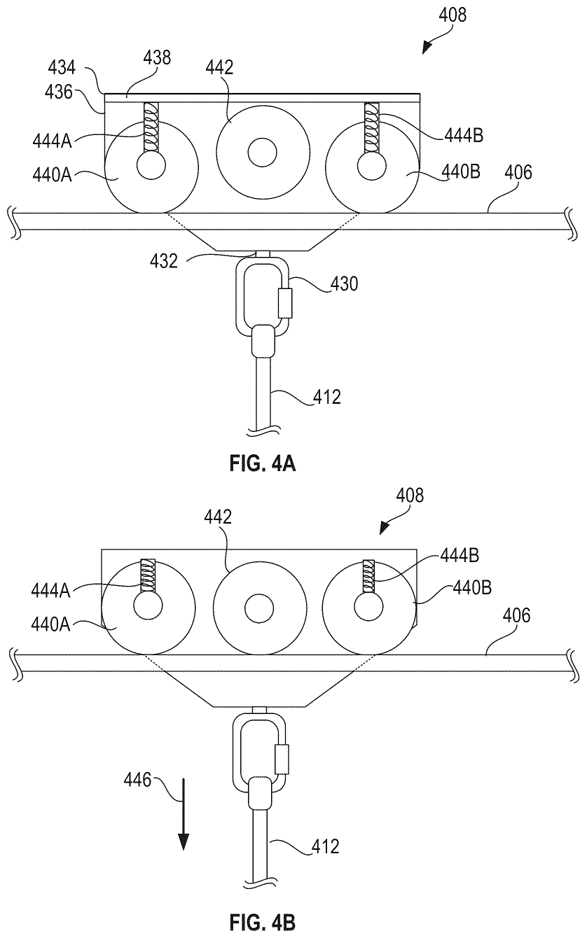

FIGS. 4A and 4B are conceptual cross-sectional views of an example a fall protection system trolley 408. Trolley 408 may be the same as or substantially similar to trolleys 108, 208, and 308 described above in reference to FIGS. 1 through 3, except for the differences describe herein. For example, trolley 408 is movably engaged with at least a portion of an overhead support structure 406 and removable coupled with a lanyard 412 via a carabiner 430 and a swivel 432.

Trolley 408 includes a housing 434 which includes opposing side-plates 436 and a cross member 438 extending therebetween. Housing 434 supports at least one wheel, such as free wheels 440A and 440B (collectively, free wheels 440) and optional friction wheel 442. For example, housing 434 can optionally be coupled to posts and bearings supporting each of free wheels 440 and friction wheels 442.

Free wheels 440 are configured to rotate along overhead support structure 406 with minimal friction. Minimal friction as used herein is based on design constraints of free wheels 440, such as a design or selection of bearing or materials of wheels 440, the bearings, overhead support structure 406, or combinations thereof.

Friction wheel 442 is configured to, when in contact with and translating across overhead support structure 406, generate friction to slow a translation of trolley 408 more than free wheels 440. Although described as friction wheel, in other examples, trolley 408 include other friction devices such as friction brakes, pads, or other features configured to generate a friction between overhead support structure 406 and trolley 408. The friction produced by friction wheel 442, when in contact with and translating across overhead support structure 406, may cause trolley 408 to slow more rapidly when traversing overhead support structure 406 compared to configurations without a friction wheel 442.

Optionally, wheels 440 may be supported within housing 434 by respective springs 444A and 444B (collectively, springs 444). Springs 444 may be configured to compress a selected distance under a selected force. For example, as illustrated in FIG. 4B, under a selected load in the direction indicated by arrow 446, springs 444 compress such that friction wheel 442 contacts overhead support structure 406. In this way, trolley 408 is configured to cause a select amount of friction, via friction wheel 442, to be generated between trolley 408 and overhead support structure 406.

In some examples, the select load includes a maximum load, such as a load indicative of an athlete experiencing a fall event. In this way, when the athlete is experiencing a fall event, trolley 408 may be configured to provide a greater rate of deceleration or otherwise remain stationary. In examples in which the select load is a maximum load indicative of a fall event, the friction between trolley 408 and overhead support structure 406 may be great enough to prevent or substantially reduce movement of trolley 408 during the fall event.

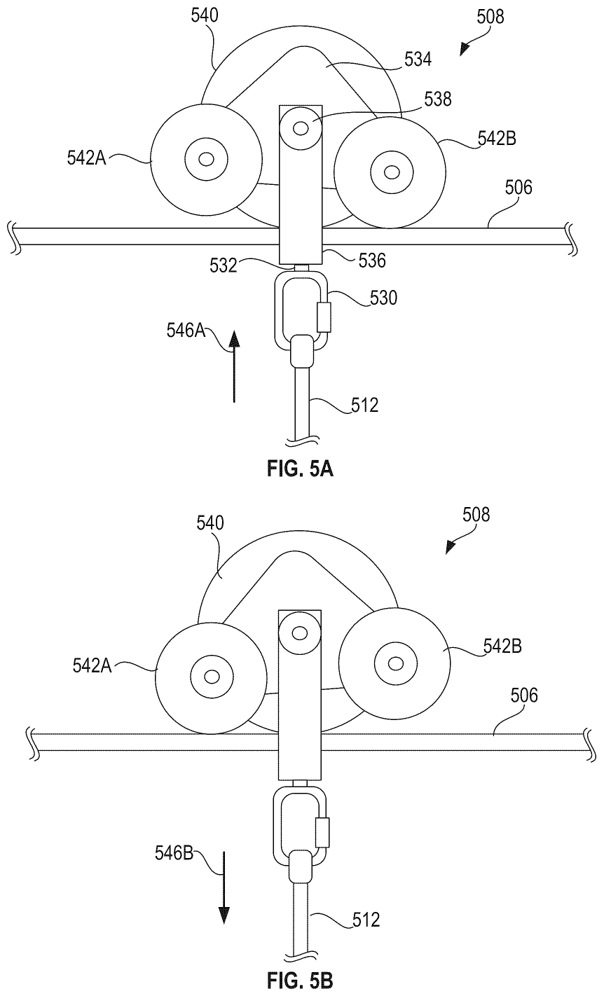

FIGS. 5A and 5B are conceptual side views of an example a fall protection system trolley 508. Trolley 508 may be the same as or substantially similar to trolleys 108, 208, 308, and 408 described above in reference to FIGS. 1 through 4B, except for the differences describe herein. For example, trolley 508 is movably engaged with at least a portion of an overhead support structure 506 and removable coupled with a lanyard 512 via a carabiner 530 and a swivel 532.

Trolley 508 includes a friction device 534 that is pivotally coupled to opposing side-arms 536 at a hub 538. A hub 538 coupled opposing side-arms and supports free wheel 440. Friction device 534 is spring biased to rotate about hub 538 based on a selected load applied to lanyard 512 and supports friction wheels 542A and 542B (collective, friction wheels 542).

Under a load less than a selected threshold, e.g., a minimum load, such as a load indicative of an athlete experiencing an airborne event or a direction change, as indicated by arrow 546A in FIG. 5A, the spring bias of friction device 534 about hub 538 causes friction wheel 542B to contact overhead support structure 506 and generate a first friction therebetween. In this way, trolley 508 is configured to provide a greater rate of deceleration when an athlete experiences an airborne event or a change in direction, thereby reducing or preventing trolley 508 from overriding or otherwise travelling too far past the athlete. Additionally, or alternatively, when the athlete is experiencing an airborne event, trolley 508 may be configured to remain stationary to provide enhanced catching if the airborne event results in a fall event. For example, by remaining stationary trolley 508 may reduce lag in activation of a self-retracting fall arrestor caused by movement of the trolley during the fall event. In the case of a fall event immediately following the airborne event, the trolley 508 may thereby be in a better position to support athlete compared to a system in which trolley continued to roll freely during the airborne event.

Additionally, under a load greater than a selected threshold, e.g., a maximum load, such as a load indicative of an athlete experiencing a fall event, as indicated by arrow 546B in FIG. 5B, the load counteracts the spring bias of friction device 534 about hub 538 and causes friction wheel 542A to contact overhead support structure 506. In this way, when athlete is experiencing a fall event, trolley 508 may be configured to provide a greater rate of deceleration or otherwise remain stationary. In examples in which the select load is a maximum load indicative of a fall event, the friction between trolley 508 and overhead support structure 506 may be great enough to prevent or substantially reduce movement of trolley 508 during the fall event.

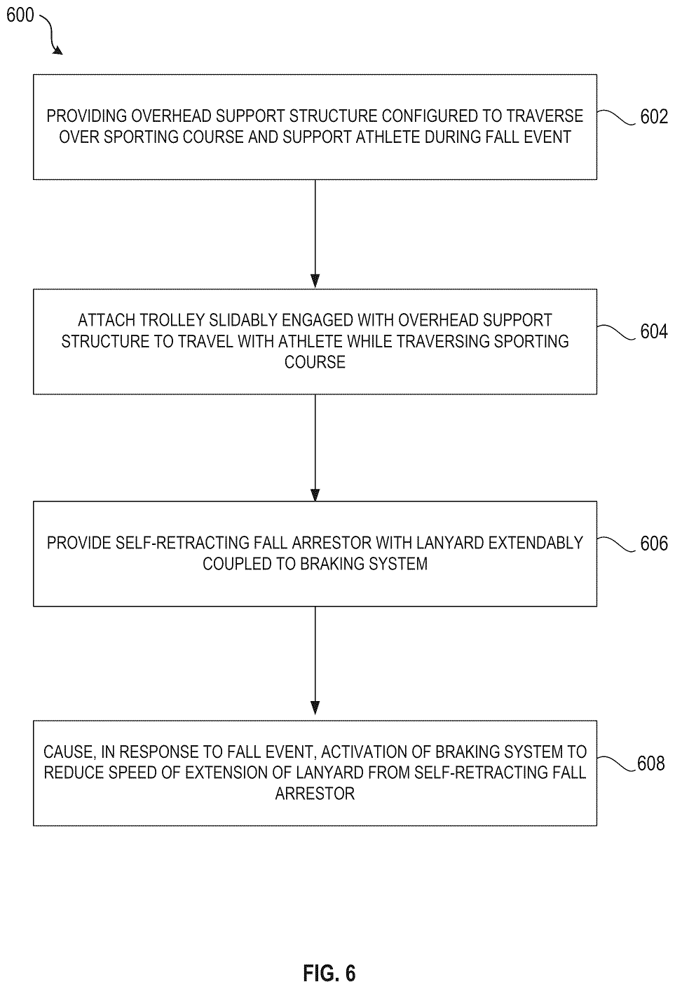

FIG. 6 is a flow diagram illustrating an example technique 600 to reduce the likelihood of an athlete impacting the sporting course, reduce the force of the athlete impacting the sporting course, control a direction of the athlete during a fall event or after impact with the sporting course, or combinations thereof. Although technique 600 is described with reference to fall protection system 104 of sporting venue 100 illustrated in FIG. 1, technique 600 may be used with other fall protection systems. Additionally, fall protection system 104 may be used with other techniques.

The method for preventing falls on sporting courses provided in technique 600 includes providing overhead support structure 106 configured to traverse over at least a portion of sporting course 102 and support the weight of athlete 116 during a fall event (602). In some examples, overhead support structure 106 includes a height adjustment features, such as moveable cables or posts, and technique 600 includes adjusting a height of overhead support structure 106 relative to at least a portion of sporing course 102. Such optional height adjustments are made to accommodate different features of sporting course 102, including, but not limited to, alteration of obstacles or their respective locations in sporting course 102.

In examples in which, overhead support structure 106 includes at least one longitudinal member 320 and at least one lateral member 322 coupled in a sliding engagement to longitudinal member 320, trolley 108 being coupled to lateral member 322; technique 600 further includes causing, in response athlete 116 traversing sporting course 102, lateral member 322 to traverse a portion of longitudinal member 320. In this way, technique 600 includes enabling trolley 108 to track more closely to athlete 116 traversing a two-dimensional plane define by sporting course 102 compared to a fall protection system without the longitudinal and lateral members.

Technique 600 also includes attaching trolley 108 slidably engaged with overhead support structure 106 to travel with athlete 116 while traversing sporting course 102 (604). In some examples, technique 600 includes a quick-release mechanism of trolley 108 to overhead support structure 106 without tools or additional hardware.

Technique 600 also includes providing self-retracting fall arrestor 110 including lanyard 112 operably coupled to a braking system (606). The braking system of self-retracting fall arrestor 110 includes at least one of an electromagnetic brake, a centripetal force brake, or a hydraulic brake configured to prevent or slow a fall of athlete 116 during a fall event. Lanyard 112 is configured to couple to harness 114 of athlete 116.

In some examples, technique 600 includes adjusting a length of lanyard 112 extending from self-retracting fall arrestor 110 to accommodate a height, a weight, a skill level, or a preference of athlete 116. Such adjustments of lanyard 112 may cause self-retracting fall arrestor 110 to activate the braking system closer or further from a surface of sporting course 102. Additionally, or alternatively, the self-retracting fall arrestor is designed with a user-friendly interface for adjusting the braking system and other settings without requiring tools, and technique 600 includes adjusting self-retracting fall arrestor 110 to change at least one of a force required to activate the braking system or a force of retraction of lanyard 112.

Technique 600 also includes causing, in response to the fall event, activation of the braking system to at least reduce a speed of an extension of lanyard 1112 from self-retracting fall arrestor 110 (608). In some examples, causing activation of the braking system includes causing induction of magnetic eddy current in at least a portion of an electromagnetic brake system. As such, fall protection system 104 reduces the likelihood of athlete 116 impacting the sporting course 102, reduces the force of athlete 116 impacting the sporting course 102, controls a direction of athlete 116 during a fall event or after impact with sporting course 102, or combinations thereof.

In some examples, technique 600 includes causing, in response to a downward force on at least a portion of trolley 108 via lanyard 112, an increased friction between at least a portion of trolley 108 and at least a portion of overhead support structure 106. In some examples, technique 600 includes absorbing, by a shock absorber system of lanyard 112, at least a portion of a force caused on lanyard 112 in response to the fall event.

In some examples, technique 600 includes detecting when a fall is imminent or has occurred using inertia, sensors, accelerometers, or impact detection systems and causing the activation of the braking system. In some examples, lanyard 112 includes a safety indicator such as a light or audio device activated by a fall, and technique 600 includes generating, by the safety indicator, in response to the fall event, an indication that a fall has occurred.

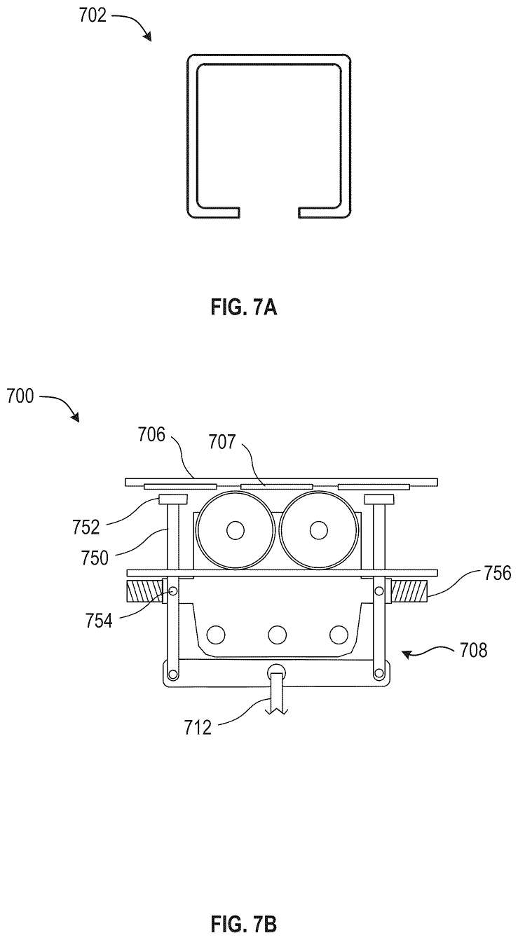

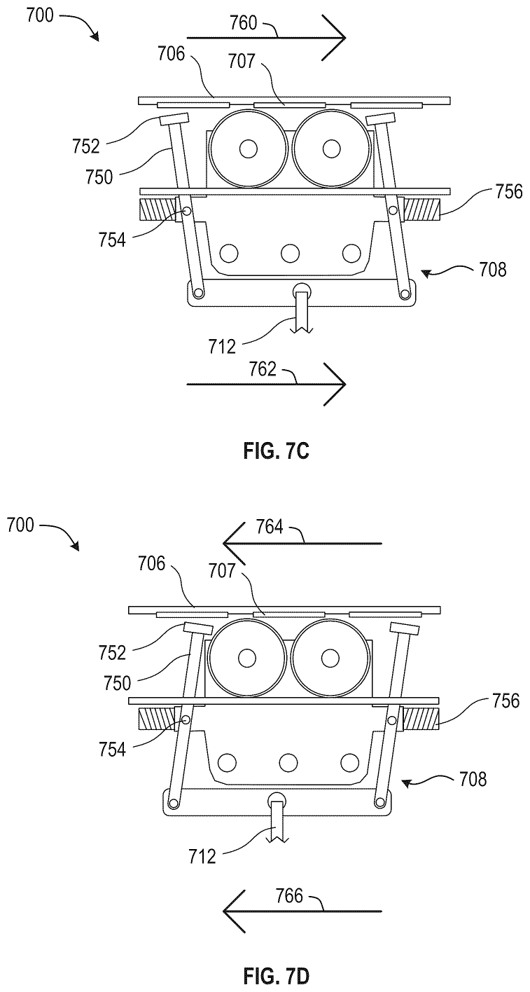

FIGS. 7A through 7D are conceptual diagrams illustrating an example maglev trolley system 700 that includes a C-shaped channel track system 706 and maglev trolley assembly 708. FIG. 7A illustrates an orthogonal view of a C-shaped channel 702. The C-shaped channel 702 may serve as a track component within the system, providing a guided pathway for other components to move along.

The C-shaped channel 702 features a rectangular cross-sectional profile with an opening along its bottom side, creating the distinctive C-shape. The channel 702 includes two parallel vertical walls connected by a horizontal top section, forming the upper portion of the C-shape. The interior space of the C-shaped channel 702 creates a pathway that may allow for components to move within it while being retained by the C-shaped profile.

In some examples, the C-shaped channel 702 may have rounded corners at the transitions between the vertical and horizontal sections. The opening at the bottom of the C-shape may be sized to allow clearance for connecting elements, permanent magnets, or both while maintaining the structural integrity of the track. The walls of the C-shaped channel 702 may maintain consistent thickness throughout the profile. This consistent thickness may contribute to the overall strength and durability of the channel 702.

In some implementations, the C-shaped channel 702 may be designed for mounting or integration into a larger system, such as architectural ceiling or roof trusses or other building components. The C-shaped profile may provide both guidance and containment for moving components. The configuration may allow for linear movement along the length of the track while maintaining lateral stability through the enclosed channel design.

The dimensions and material of the C-shaped channel 702 may be selected based on the specific requirements of the fall protection system. These dimensions may include the overall width and height of the channel, as well as the thickness of the walls and the size of the bottom opening. In some examples, the material used for the C-shaped channel 702 may be selected for strength, durability, and resistance to environmental factors. Possible materials may include metals, high-strength polymers, or composite materials.

The C-shaped channel 702 may facilitate controlled linear motion while providing support and guidance through its enclosed channel configuration. The retention provided by the C-shaped profile may enable components to remain securely within the track while allowing necessary clearance through its bottom opening.

FIGS. 7B-7D illustrate various views of a maglev trolley system 700 for use in a fall protection system. The maglev trolley system 700 may be configured to operate within the C-shaped channel 702 described in reference to FIG. 7A.

As shown in FIG. 7B, the maglev trolley system 700 includes an overhead support 706 that may be positioned above a sporting course. A C-channel magnet strip 707 may be attached to an upper surface of the overhead support 706. The C-channel magnet strip 707 may extend along the length of the overhead support 706.

A trolley 708 may be positioned within the C-shaped channel 702 and configured to move along the length of the overhead support 706. The trolley 708 may include free wheels 742 that enable smooth movement within the C-shaped channel 702. In some examples, the free wheels 742 may be made of a low-friction material to facilitate easy movement of the trolley 708.

A pendulum arm 750 may extend downward from the trolley 708. The pendulum arm 750 may be connected to the trolley 708 at a pendulum hinge point 754. This connection may allow the pendulum arm 750 to swing back and forth relative to the trolley 708. A pendulum magnet 752 may be positioned at an upper portion of the pendulum arm 750. The pendulum magnet 752 may be configured to interact with the C-channel magnet strips 707.

Spring loaded bump stops 756 may be positioned on either side of the pendulum hinge point 754. In some examples, these spring-loaded bump stops 756 may serve to limit the range of motion of the pendulum arm 750 and provide damping when the pendulum arm 750 reaches its maximum swing in either direction. Additionally, or alternatively, spring loaded bump stops 756 may damp impact of trolley 708 with terminal ends of overhead support 706.

An athlete may be connected to the trolley 708 via a lanyard 712 and harness. This connection may allow an athlete wearing the harness to move freely while remaining securely attached to the maglev trolley system 700. In some examples, the maglev trolley system 700 may include a 360-degree ball joint at the base of the trolley 708. This ball joint may provide additional freedom of movement for the athlete while maintaining a secure connection to the system.

FIGS. 7C and 7D illustrate the operation of the maglev trolley system 700 as an athlete moves in different directions. In FIG. 7C, as indicated by athlete direction arrow 762, the athlete may be moving to the right. This movement may cause the pendulum arm 750 to swing to the left, bringing the pendulum magnet 752 closer to the C-channel magnet strip 707 on the left side. The magnetic interaction between the pendulum magnet 752 and the C-channel magnet strip 707 may cause the trolley 708 to move in the direction indicated by trolley direction arrow 760. That is, the proximity of the pendulum magnet 752 to the C-channel magnet strip 707 may create a magnetic interaction. This interaction may generate a force that urges the trolley 708 to move in the direction indicated by the trolley direction arrow 760, which corresponds to the athlete's movement direction.

Conversely, in FIG. 7D, the athlete may be moving to the left as indicated by athlete direction arrow 766. This may cause the pendulum arm 750 to swing to the right, bringing the pendulum magnet 752 closer to the C-channel magnet strip 707 on the right side. The resulting magnetic interaction may cause the trolley 708 to move in the direction indicated by trolley direction arrow 764. The magnetic interaction between the pendulum magnet 752 and the C-channel magnet strip 707 on the right side may generate a force that propels the trolley 708 in the direction indicated by the trolley direction arrow 764. This direction may correspond to the athlete's new movement direction.

In some examples, the magnetic interaction between the pendulum magnet 752 and the C-channel magnet strip 707 may serve to automatically slow or stop the trolley 708 when the athlete changes direction or experiences a fall. For example, when the athlete abruptly changes direction, the pendulum arm 750 may swing rapidly to the opposite side. This rapid swing may cause the pendulum magnet 752 to interact with the C-channel magnet strip 707 in a manner that generates a braking force on the trolley 708.

The maglev trolley system 700 may utilize the magnetic interactions to provide a self-regulating mechanism for trolley movement. When the athlete is in motion, the system may urge the trolley 708 to move along with the athlete. However, during sudden changes in direction or potential fall events, the same magnetic interactions may act to slow or stop the trolley 708, potentially enhancing the safety features of the system.

In some examples, the pendulum hinge point 754 may allow for a range of motion of the pendulum arm 750, enabling the system to respond to various athlete movements and speeds. The free wheels 742 of the trolley 708 may facilitate smooth movement along the C-shaped channel 702, while the magnetic interactions provide the driving and braking forces.

The harness 712, connected to the trolley 708, may allow the athlete to move freely while remaining securely attached to the maglev trolley system 700. The system's ability to respond to athlete movements and direction changes may help maintain an appropriate position of the trolley 708 relative to the athlete, potentially enhancing the effectiveness of the fall protection system.

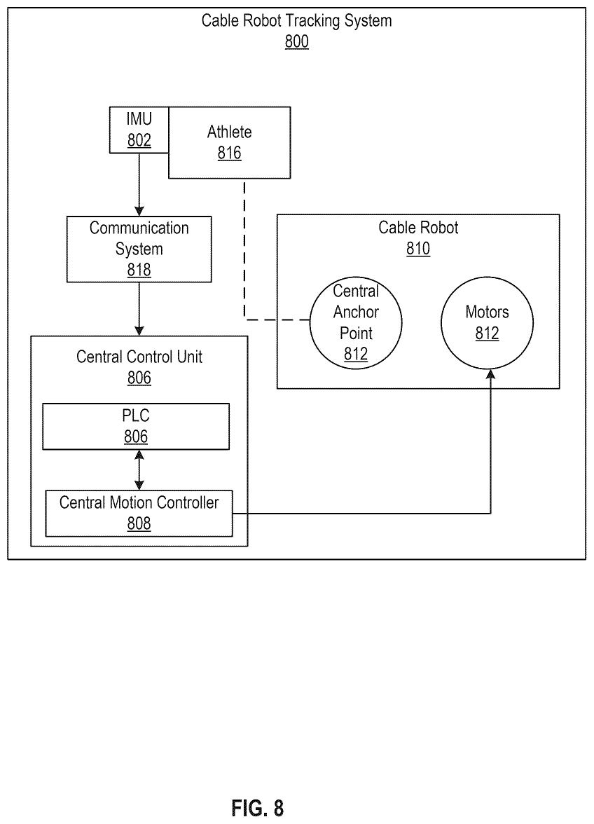

FIG. 8 illustrates a system diagram of a cable robot tracking system 800. The system includes an inertial measurement unit (IMU) 802, which may be implemented using a smartphone or other device having an inertial measurement unit, for tracking motion. A central control unit 804 manages the overall system operation and includes a programable logic controller (PLC) 806 and a central motion controller 808. The system also includes a cable robot 810 with four motors 812 and a central anchor point 814. An athlete 816 interacts with the system, and a communication system 818 facilitates data transfer between components.

The IMU 802 may connect to the communication system 818, indicating a data link. The communication system 818 may then relay information to the central control unit 804. Within the central control unit 804, the PLC 806 and central motion controller 808 may be interconnected, enabling two-way communication. The central motion controller 808 may send commands to the motors 812 of the cable robot 810.

The athlete 816 may be connected to the central anchor point 814 of the cable robot 810, which may represent a physical connection or a tracking relationship. The system may operate by collecting motion data from the IMU 802, processing this information through the central control unit 804, and adjusting the cable robot 810 accordingly to track or assist movements of the athlete 816.

The diagram indicates a modular architecture where components may communicate through defined interfaces. The communication system 818 may include any suitable type of wireless data transmission between the IMU 802 and the central control unit 804.

The IMU 802 is preferably worn by the athlete on their helmet and combines a gyroscope sensor that measures and signals direction, and an accelerometer that measures angular velocity/speed. This sensor provides the basis for the signals that control the system and track the athlete. Any type of device that provides and is capable of exporting kinematic data in real time can be used to extrapolate the required data. This can include a stand-alone IMU unit, an Apple Watch, or a personal cell phone for example. The IMU unit extrapolates speed and direction data and exports it in real time to the PLC 806. Direction and velocity data comes from the sensor and is based on the actions of the athlete. If the athlete moves in Direction A at 5 ft. per second, then abruptly changes direction and moves in Direction B at 8 feet per second, the data from those moves is logged and then exported in real time to the PLC 806 based on the direction and speed that the athlete is moving in.

Once the PLC 806 receives the data from the IMU 802, it translates this data into step and direction signals that it sends to the central motion controller 808. The central motion controller 808 communicates with the motor drivers that control each of the 4 motors 812 at the corners of the active skating or sports area. The athlete tracking system may include an upright support post at each corner of the active skating or sports area. These support posts may provide structural support for the cable robot 810 and may serve as anchor points for the cables connected to the central anchor point 814. Additionally, or alternatively, cable robot 810 may be supported by an overhead structure.

The central motion controller 808 is a dedicated computer system that receives data from the PLC 806. Upon receiving this data in real time, the central motion controller 808 translates that data in real time and converts it into step and direction signals. These step and direction signals then tell the motor drivers (motor controllers) which direction to move in and how fast to do so. This is based on an algorithm that equates the synchronized, kinematic movement of the athlete and how each of the four motors must move in synchronicity to allow the system to follow the athlete around the active skating or sports area. In some implementations, the athlete tracking system may use a gear-ratioed motor at the base of each support post. These motors may correspond to the motors 812 shown in the diagram. The gear-ratio configuration may allow for precise control of the cable tension and movement, enabling accurate tracking of the position of athlete 816 within the active area.

The cable robot 810 may operate by adjusting the lengths of the cables connected to the central anchor point 814 using the motors 812. By coordinating the movements of these cables, the system may be able to position the central anchor point 814 at any point within the three-dimensional space of the active area, allowing for continuous tracking of the athlete 816. When all the above components are integrated together and programmed correctly, they create a system that functions by following the athlete as they move about the active skating or sports area. This method of following the athlete is completely autonomous and requires no active input from the user other than to move about the course or area. By doing this, a system that essentially follows the athlete around the course as they move is created. This allows the fall restraint system to follow the athlete around and be positioned where needed when needed without creating any resistance or encumbrance on the athlete.

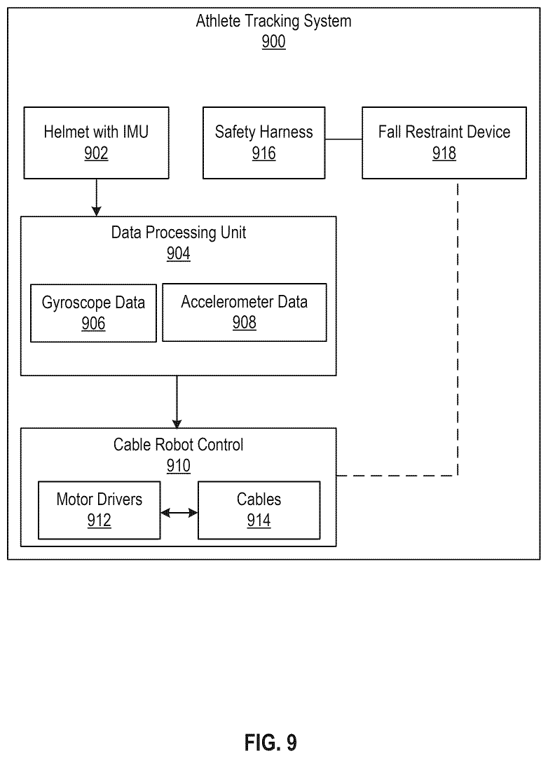

FIG. 9 illustrates a block diagram of an athlete tracking system 900. The athlete tracking system 900 may include a helmet sensor 902, a data processing unit 904, a cable robot control 910, and a fall restraint device 918.

The helmet sensor 902 may be configured to measure direction in six axes, allowing for comprehensive data measurement in every available direction. In some examples, the helmet sensor 902 may be implemented as a stand-alone IMU unit, an Apple Watch, or a personal cell phone. The helmet sensor 902 may be connected to the data processing unit 904.

The data processing unit 904 may include a programmable logic controller (PLC). The data processing unit 904 may contain two data collection modules: gyroscope data 906 and accelerometer data 908. These modules may process the information received from the helmet sensor 902.

The data processing unit 904 may be connected to the cable robot control 910. The cable robot control 910 may include motor drivers 912. The motor drivers 912 may be connected to control cables 914, which may be used to control the movement of the system.

A safety harness 916 may be included in the athlete tracking system 900. The safety harness 916 may be connected to a fall restraint device 918. In some examples, the fall restraint device 918 may be computer and sensor controlled.

The athlete tracking system 900 may operate by collecting motion data from the helmet sensor 902. This data may be processed by the data processing unit 904, which may use the gyroscope data 906 and accelerometer data 908 to determine the athlete's position and movement. The processed data may then be sent to the cable robot control 910, which may use the motor drivers 912 to adjust the control cables 914 accordingly.

In some examples, the fall restraint device 918 may receive input from the data processing unit 904 to adjust its operation based on the athlete's movement. This may allow for dynamic fall protection that adapts to the athlete's position and velocity in real-time.

The athlete tracking system 900 may provide a comprehensive solution for monitoring and protecting athletes during activities. By combining motion sensing, data processing, and adaptive fall protection, the system may offer enhanced safety features compared to traditional static fall protection systems.

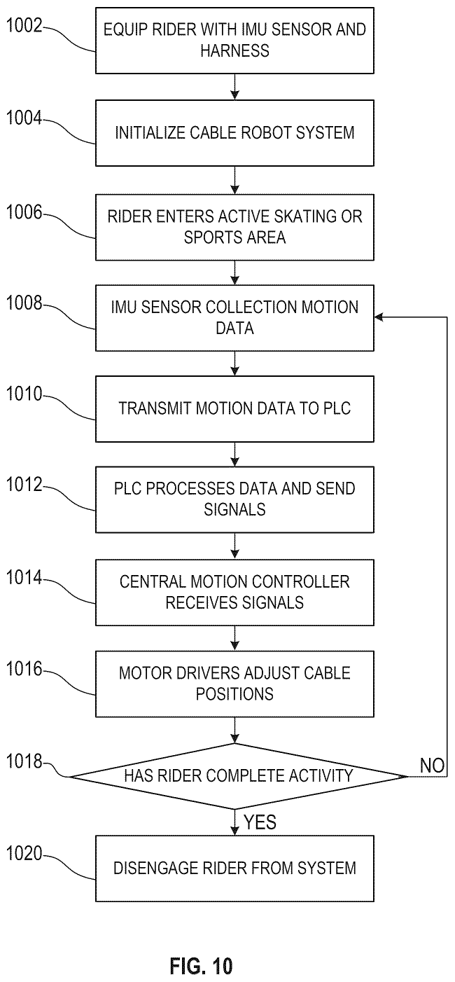

FIG. 10 illustrates a method 1000 for operating a cable robot tracking system. The method 1000 may include a series of steps that form a continuous loop of data collection, processing, and mechanical adjustment to track and support an athlete during activities.

The method 1000 may begin with a step 1002 of equipping a rider with an IMU sensor and harness. In some examples, the IMU sensor may be part of the helmet sensor 902 described in reference to FIG. 9. The harness may be similar to the safety harness 916.

A step 1004 may involve initializing the cable robot system. This initialization may include powering on the system components, performing system checks, and ensuring all connections are secure.

In a step 1006, the rider may enter the active skating or sports area. This area may be the space monitored and controlled by the cable robot tracking system.

The method 1000 may continue with a step 1008 of collecting motion data from the rider's movements via the IMU sensor. This data collection may be continuous and may include information about the rider's position, velocity, and acceleration in multiple axes.

A step 1010 may involve transmitting the collected motion data to a PLC. In some examples, this transmission may occur through the data processing unit 904 described in reference to FIG. 9.

The method 1000 may proceed to a step 1012 where the PLC processes the data and sends signals. This processing may involve analyzing the raw motion data to determine the rider's current state and predict future movements.

In a step 1014, a central motion controller may receive the signals from the PLC. The central motion controller may be part of the cable robot control 910 described in reference to FIG. 9.

Based on the received signals, a step 1016 may involve the motor drivers adjusting cable positions accordingly. The motor drivers 912 may control the tension and length of the control cables 914 to maintain the rider's position within the active area and provide support as needed.

The method 1000 may then reach a decision point in step 1018, determining if the rider has completed their activity. If the rider has not completed their activity, the method 1000 may loop back to step 1008, continuing the cycle of data collection, processing, and mechanical adjustment.

If the rider has completed their activity, the method 1000 may proceed to a step 1020 where the rider is disengaged from the system. This disengagement may involve removing the harness and IMU sensor and may include a system shutdown procedure.

In some examples, the continuous loop of steps 1008 through 1018 may allow the cable robot tracking system to provide real-time support and protection for the rider. The system may adjust to the rider's movements with minimal lag, potentially enhancing safety during high-speed or complex maneuvers.

The method 1000 may incorporate data from both the gyroscope data 906 and accelerometer data 908 to provide comprehensive tracking of the rider's movements. This multi-dimensional data may allow for more accurate predictions of the rider's trajectory and potential fall scenarios.

In some implementations, the fall restraint device 918 may be integrated into the method 1000, with its operation adjusted based on the processed motion data. For example, the tension in the fall restraint device 918 may be dynamically adjusted based on the rider's current speed and position within the active area.

The method 1000 may provide a systematic approach to operating the cable robot tracking system, ensuring continuous monitoring and support for the rider throughout their activity. By combining sensor data, real-time processing, and mechanical adjustments, the method 1000 may enable a responsive and adaptive fall protection system.

The following clauses illustrate example subject matter described herein.

Clause 1. A maglev trolley system, comprising: a C-shaped channel defining at least a portion of an overhead support; a C-channel magnet strip attached to an upper surface of the C-shaped channel; a trolley positioned within the C-shaped channel and configured to move along the C-shaped channel; a pendulum arm extending downward from the trolley and connected at a pendulum hinge point; and a pendulum magnet positioned at an upper portion of the pendulum arm, configured to interact with the C-channel magnet strip.

Clause 2. The maglev trolley system of clause 1, further comprising free wheels attached to the trolley and configured to enable movement along the C-shaped channel.

Clause 3. The maglev trolley system of clause 2, further comprising spring loaded bump stops positioned on either side of the pendulum hinge point.

Clause 4. The maglev trolley system of clause 3, wherein the spring-loaded bump stops are configured to limit a range of motion of the pendulum arm.

Clause 5. The maglev trolley system of clause 1, further comprising a harness connection point extending downward from a central portion of the trolley.

Clause 6. The maglev trolley system of clause 5, wherein the harness connection point is configured to connect to an adjustable cable for attaching to a harness worn by an athlete.

Clause 7. The maglev trolley system of clause 6, further comprising a 360-degree ball joint at a base of the trolley, wherein the 360-degree ball joint is configured to provide additional freedom of movement for the athlete while maintaining a secure connection to the system.

Clause 8. A cable robot tracking system, comprising: an IMU unit configured to collect motion data; a central control unit comprising a PLC and a central motion controller; a cable robot comprising a plurality of motors and a central anchor point; and a communication system configured to facilitate data transfer between the IMU unit and the central control unit.

Clause 9. The cable robot tracking system of clause 8, wherein the IMU unit comprises a gyroscope and an accelerometer configured to measure direction and velocity data of an athlete.

Clause 10. The cable robot tracking system of clause 9, wherein the central control unit is configured to translate the direction and velocity data into step and direction signals for controlling the plurality of motors.

Clause 11. The cable robot tracking system of clause 10, wherein the plurality of motors comprises four motors positioned at corners of an active sports area.

Clause 12. The cable robot tracking system of clause 11, wherein each of the four motors is configured to spool and unspool a cable connected to the central anchor point.

Clause 13. The cable robot tracking system of clause 12, further comprising a safety harness connected to the central anchor point via a fall restraint device.

Clause 14. The cable robot tracking system of clause 13, wherein the fall restraint device comprises a self-retracting lanyard configured to activate in response to sudden movements or falls detected by the IMU unit.

Clause 15. A method for operating a cable robot tracking system, comprising: equipping a rider with an IMU sensor and harness; initializing a cable robot system; collecting motion data from the rider's movements via the IMU sensor; transmitting the collected motion data to a PLC; processing the data and sending signals from the PLC to a central motion controller; and adjusting cable positions based on the signals received by the central motion controller.

Clause 16. The method of clause 15, wherein collecting motion data comprises measuring direction and velocity data of the rider using a gyroscope and an accelerometer in the IMU sensor.

Clause 17. The method of clause 16, wherein processing the data comprises translating the direction and velocity data into step and direction signals for controlling a plurality of motors in the cable robot system.

Clause 18. The method of clause 17, wherein adjusting cable positions comprises spooling and unspooling cables connected to a central anchor point using the plurality of motors positioned at corners of an active sports area.

Clause 19. The method of clause 18, further comprising connecting a safety harness to the central anchor point via a fall restraint device.

Clause 20. The method of clause 19, wherein the fall restraint device comprises a self-retracting lanyard configured to activate in response to sudden movements or falls detected by the IMU sensor.

Clause 21. A fall protection system for an action sports course, comprising: an overhead support structure comprising one or more cables or trusses extending over the sporting course and configured to support the weight of the athlete; a trolley slidably engaged with the overhead support structure and configured to travel with the athlete while traversing the sporting course; a self-retracting fall arrestor comprising a braking system that is electromagnetic, centripetal force, or hydraulic, wherein the braking system is configured to prevent or slow a fall of the athlete; and a lanyard extending from the self-retracting fall arrestor for coupling to a harness of the athlete.

Clause 22. The fall protection system of clause 21, wherein the overhead support structure comprises at least one longitudinal member and at least one lateral member coupled in a sliding engagement, wherein the trolley is coupled to the at least one lateral member.

Clause 23. The fall protection system of clause 21, wherein the trolley is made of metal (e.g., aluminum or steel), plastic, or composite materials and comprises rounded edges, low-friction coatings, adjustable wheel sizes, and/or quick-release mechanisms for easy maintenance and replacement.

Clause 24. The fall protection system of clause 21, wherein the self-retracting fall arrestor uses an electronic brake system that employs eddy current braking to prevent or slow the fall of the athlete.

Clause 25. The fall protection system of clause 21, wherein the lanyard is made of nylon, polyester, Kevlar, or other materials providing strength and durability while minimizing weight, and comprises a carabiner or quick-release mechanism for easy maintenance and replacement.

Clause 26. The fall protection system of clause 21, further comprising an adjustable height feature on at least one of the overhead support structure or the lanyard to accommodate different athlete sizes and skill levels.

Clause 27. The fall protection system of clause 21, wherein the trolley is configured to traverse a two-dimensional area over the sporting course using longitudinal members and lateral members coupled in a sliding engagement with trolleys.

Clause 28. The fall protection system of clause 21, wherein the self-retracting fall arrestor comprises an interchangeable component for adjusting the braking system to accommodate different weights and sizes of athletes.

Clause 29. The fall protection system of clause 21, further comprising a detachable or adjustable lanyard design to ensure safe coupling with the harness of the athlete.

Clause 30. The fall protection system of clause 21, wherein the overhead support structure comprises vertical supports to traverse a 3-dimensional area over the sporting course and provide additional stability during falls.

Clause 31. The fall protection system of clause 21, further comprising a remote control or wireless activation system for the self-retracting fall arrestor to allow for easy operation by the athlete or coach.

While the disclosure has been described in connection with what is presently considered to be the most practical and preferred embodiments, it is to be understood that the disclosure is not to be limited to the disclosed embodiments, but on the contrary, is intended to cover various modifications and equivalent arrangements included within the spirit and scope of the appended claims, which scope is to be accorded the broadest interpretation so as to encompass all such modifications and equivalent structures as permitted under the law. Furthermore, it should be understood that while the use of the word preferable, preferably, or preferred in the description above indicates that feature so described may be more desirable, it nonetheless may not be necessary and any embodiment lacking the same may be contemplated as within the scope of the disclosure, that scope being defined by the claims that follow. In reading the claims it is intended that when words such as “a,” “an,” “at least one” and “at least a portion” are used, there is no intention to limit the claim to only one item unless specifically stated to the contrary in the claim. Further, when the language “at least a portion” and/or “a portion” is used the item may include a portion and/or the entire item unless specifically stated to the contrary.

What is claimed is:

1. A sporting venue comprising:
a sporting course having a first topography over which an athlete traverses;
an overhead support structure comprising one or more cables or trusses extending over the sporting course and configured to support a weight of the athlete;
a trolley slidably engaged with the overhead support structure and configured to travel with the athlete while traversing the sporting course;
a self-retracting fall arrestor comprising a lanyard operably coupled to a braking system configured to prevent or slow a fall of the athlete, wherein the braking system comprises at least one of an electronic brake, an electromagnetic brake, a centripetal force brake, or a hydraulic brake; and
a lanyard extending from the self-retracting fall arrestor and configured to couple to a harness of the athlete.

2. The sporting venue of claim 1, wherein the overhead support structure comprises at least one longitudinal member and at least one lateral member coupled in a sliding engagement, wherein the trolley is coupled to the at least one lateral member.

3. The sporting venue of claim 1, wherein the overhead support structure defines a second topography corresponding to the first topography.

4. The sporting venue of claim 1, wherein the trolley is configured to rotate about a z-axis while traveling with the athlete.

5. The sporting venue of claim 1, wherein the trolley is configured to provide a select amount of friction between the trolley and the overhead support structure.

6. The sporting venue of claim 1, wherein at least one of the self-retracting fall arrestor and the trolley is configured to automatically lock in place after a fall has been detected.

7. The sporting venue of claim 1, wherein the lanyard comprises a shock-absorbing components, impact-resistant materials, and reflective or luminescent elements.

8. The sporting venue of claim 1, wherein at least one of the trolley, the self-retracting fall arrestor, and the lanyard is adjustable for athletes of different sizes and weights.

9. The sporting venue of claim 1, further comprising a harness extension configured to urge the lanyard away from a portion of an upper body of the athlete during use.

10. The sporting venue of claim 1, wherein the braking system of the self-retracting fall arrestor is electromagnetic and comprises an eddy current brake.

11. A method for preventing falls on a sporting course, wherein the method comprises:
providing an overhead support structure configured to traverse over at least a portion of the sporting course and support a weight of the athlete during a fall event;
attaching a trolley slidably engaged with the overhead support structure to travel with the athlete while traversing the sporting course;
providing a self-retracting fall arrestor comprising a lanyard operably coupled to a braking system, wherein the braking system comprises at least one of an electromagnetic brake, a centripetal force brake, or a hydraulic brake configured to prevent or slow a fall of the athlete, and wherein the lanyard is configured to couple to a harness of the athlete; and
causing, in response to a fall event, activation of the braking system to at least reduce a speed of an extension of the lanyard from the self-retracting fall arrestor.

12. The method of claim 11, wherein at least one of the overhead support structure and the lanyard comprises an adjustable height feature for customizing a height of the fall protection system to accommodate different sporting courses and athlete sizes.

13. The method of claim 11, wherein the method further comprises causing, in response to a downward force on at least a portion of the trolley via the lanyard, an increased friction between the trolley and at least a portion of the overhead support structure.

14. The method of claim 11, wherein the method further comprises absorbing, by a shock absorber system of the lanyard, at least a portion of a force caused on the lanyard in response to the fall event.

15. The method of claim 11, wherein causing activation of the braking systems comprises causing induction of magnetic eddy current in at least a portion of the electromagnetic brake system.

16. The method of claim 11, wherein the method further comprises detecting when the fall is imminent or has occurred using inertia, sensors, accelerometers, or impact detection systems.

17. The method of claim 11, wherein the overhead support structure comprises at least one longitudinal member and at least one lateral member coupled in a sliding engagement, wherein the trolley is coupled to the at least one lateral member, and wherein the method further comprises causing, in response the athlete traversing the sporting course, the at least one lateral member to traverse a portion of the at least one longitudinal member.

18. The method of claim 11, wherein attaching the trolley comprises attaching a quick-release mechanism of the trolley to the overhead support structure without tools or additional hardware.

19. The method of claim 11, wherein the self-retracting fall arrestor is designed with a user-friendly interface for adjusting the braking system and other settings without requiring tools.

20. The method of claim 11, wherein the lanyard comprises a safety indicator activated by the fall, wherein the method further comprises generating, by the safety indicator, an indication that a fall has occurred.
